(19) United States
(12) Patent Application Publication
(10) Pub. No.: US 2011/0200211 A1
(43) Pub. Date: Aug. 18, 2011

(54) ACOUSTICS TRANSMISSION FIDELITY AUGMENTATION INTERFACE FOR INERTIAL TYPE AUDIO TRANSDUCERS

(76) Inventors: Robert Katz, Quebec (CA); Stephen Saint-Vincent, New Braunfels, TX (US)

(21) Appl. No.: 13/123,281

(22) PCT Filed: Oct. 9, 2009
(86) PCT No.: PCT/IB09/07360

§ 371 Date: Apr. 8, 2011

(51) Int. Cl. H04R 25/00

(52) U.S. Cl. 381/150

(57) ABSTRACT

An acoustical transmission interface comprising a plate comprising a first portion having a first thickness and a second portion having a second thickness wherein the first thickness is thinner than the second thickness; an inertial type audio transducer; and means to affix the audio transducer and the first portion of the plate; where the audio transducer extends through an opening in a substrate, and the plate comprising a tab and a stop that position the plate within the opening of the substrate.

### FIELD OF THE INVENTION

The present invention generally relates to associating an audio transducer with a substrate to create a soundboard and, more specifically, to an interface device which inserts into a substrate and which acts as an acoustic fidelity augmentation bridge between an inertial type audio transducer and the chosen substrate.

### BACKGROUND OF THE INVENTION

Inertial type audio transducers have been applied to various substrates permitting them to transfer acoustic energy to the substrate. Various substrates have been used successfully such as wood fiberboard, fiber reinforced composites, and gypsum paneling. In so doing the substrate is set into bending wave motion by the inertial type transducer. These bending waves radiate acoustic energy through a non-linear process in which acoustically radiating wave numbers are present at nearly all frequencies. This type of acoustic radiator is classically called Distributed Mode Loudspeakers.

Historically, the present art of improving the frequency response of a Distributed Mode Loudspeaker is to reduce the contact area, preferably to a point, which increases the high frequency content of the energy input into the desired acoustic substrate. As the drive point contact area is decreased, the shear stress at the contact point is increased, which on frangible materials such as gypsum, causes substrate failure.

A common characteristic of the common building materials that are used for acoustic radiators are relatively stiff for the given areal mass density of the substrate. These materials typically are porous in nature leading to lower areal density. The stiffness is gained by a thickness of the substrate system or outer skins that effectively act as structural members. In Distributed Mode Loudspeakers, it is desirable to have a high stiffness to areal density. This property leads to improved radiation efficiency. However, the generally porous nature of the substrate leads to low shear modulus of the substrate.

A means to improve frequency response and augment acoustic sensitivity was needed in an arrangement that avoids decreasing the contact area to the point of substrate failure, and provides appropriate stiffness and shear modulus of the substrate.

The focus of this invention is to improve frequency response and augment acoustic sensitivity by way of the interface between the transducer and the substrate. The non-restrictive illustrative embodiment will use the example of gypsum or mineral paneling.

### SUMMARY OF THE INVENTION

It is an object of the present invention to provide a means to augment the acoustic fidelity and transmission of audio content generated by the inertial type acoustic transducer to the substrate.

It is therefore an object of the present invention to provide a system to affix an inertial type acoustic transducer to a substrate.

Another objective of the present invention is to provide an audio transmission fidelity augmentation interface between an inertial type acoustic transducer and a substrate to which it is affixed.

Yet another objective of the present invention is to provide for a means of easily assembling the audio transmission fidelity augmentation interface and inertial type acoustic transducer to the substrate.

It is yet another objective of the present invention to provide a means to affix an inertial type acoustic transducer to the inside of a gypsum type panel forming a wall, ceiling or other surface, such that the installation thereof hides the inertial type acoustic transducer such that it is not seen and is rendered not visible in standard applications.

Another objective of the present invention is to provide a means to have the transmission fidelity augmentation interface mate with more than one thickness of substrate material.

The application of inertial type transducers to a substrate is to introduce primarily bending waves into the substrate. Bending waves induced in the substrate propagate at frequency dependent speed. Nearly all real audio content contains a fairly broadband of frequency content, thus a typical audio waveform input will be altered not only in time but also in space as it propagates. The change in waveform is also a change in wavenumber. The wavenumber conversion generates modes, which consist of both radiating and non-radiating modes even though the input frequency is above the critical bending wave frequency.

The acoustic radiation efficiency is controlled by the dispersion (wavenumber/frequency) characteristics of the overall panel. In a composite panel, where two face plates are separated by a central core, the low frequency is influenced by the overall panel section stiffness, the mid frequencies by the central layer shear stiffness, and the high frequency by the bending stiffness of the face plates.

The elastic properties of the core and face plates can set up plate-core-plate dilatational resonances significantly increasing the radiation efficiency at the resonance frequency. The lower the core stiffness, the more likely this plate-core-plate resonance will occur within the desired frequency response range of the substrate. The resonance frequency may be increased, out of the frequency band of interest by locally increasing the core stiffness at the acoustic drive point.

However, locally increasing the core stiffness of the panel will adversely affect other critical properties of the panel, namely affecting the propagation of the bending wave through the acoustic drive point region and the mechanical bending wave input impedance.

Ideally, at the inertial type acoustic transducer drive point, a stiffer core material is introduced which locally increases the shear modulus, but ideally does not change the mechanical point input bending impedance, Z_{F}:

Z_{F}=8[Eh³/12(1−v²)]^{1/2}(m)^{1/2}
Where:
E is the Young's Modulus of panel
h is the thickness of panel
v is the Poisson ratio
m is the areal density of panel
   nor the bending wave critical frequency of the substrate at the acoustic drive point, c_{B}:

c_{B}=cₐ²√3/(πh)(ρ/E)
Where:
cₐ is the speed of sound in air
h is the panel thickness
ρ is the mass density of panel
E is the Young's modulus of panel.

Critical listening of drywall panels has shown that the radiation efficiency of the panel is significantly increased around 2.5 kHz. In addition, the high frequency content of drywall lacks detail, regardless of the accuracy of the frequency response. It has been observed that when the critical shear wave frequency at the inertial type acoustic transducer drive point is raised several octaves above the human hearing range, the high frequency detail is greatly improved.

During the manufacture of gypsum paneling, the wet gypsum is foamed preferentially in the center to reduce the weight of the panel while also making the panel suitable for application of mechanical fasteners to attach it to structural support framing. The portion of the gypsum panel adjacent to the surface scrim contains less air content, increasing the panel sectional stiffness. An approach to locally increase the shear velocity is to eliminate the air voids in the gypsum material. Although this will increase the shear stiffness at the drive point, it will also increase the drive point impedance, mass and flexural bending stiffness causing other undesirable affects.

One embodiment of the present invention consists of a plate type plate, which has features of reduced substrate thickness at the inertial type acoustic transducer drive point, a transition region between the transducer drive point location and the base substrate, features for enhancing the bond between the plate type plate and the gypsum panel. The plate type plate is used as a localized replacement in the base gypsum panel, where a hole of like dimensions of the plate is cut into the base gypsum panel substrate and replaced with the plate type plate. Preferably, the plate type plate is made of gypsum (calcium sulfate hemihydrate) material, where when bonded with the base gypsum panel material with setting type gypsum joint compound, form primary crystalline bonds between the two elements. Introduction of fiberglass filaments at a rate of 5-6% to gypsum of the plate type plate will create a material which has a Young's modulus nearly 20 times greater than the base gypsum panel substrate, while increasing the density only 1.54 times. A commercial example of this material is USG HydroCal FRG-95 available from the Industrial Products Division of the United States Gypsum Company.

The thinned portion of the plate is nominally 40% the thickness of the base substrate. This thinning can range from 10-90% of the base thickness of the substrate. However, the nearly optimum thickness of the thinned region is 40% of the base substrate.

A second embodiment makes use of the outer skin of a composite panel as the plate type plate and removes the core and inner skin providing a hollow into which the transducer is placed. Sectional fingers or a cylinder element are placed in the hollow and bonded to the inside of the outer skin and the core and inner skin providing adequate bending stiffness matching that of the composite panel.

It has been observed that the best acoustic performance results are obtained when the interface maximizes the Young's Modulus, minimizes the areal density, and minimally affects the bending wave input impedance and bending wave critical frequency. Additionally, the ideal material will form primary crystalline bond with the overall gypsum (calcium sulfate hemihydrate) panel.

The above mentioned principal, of locally increasing the core stiffness while maintaining the bending wave input impedance and bending wave critical speed is suitable to all types of composite panels that consist of external layers and a central core.

### BRIEF DESCRIPTION OF THE DRAWINGS

In the appended drawings:

FIG. 1 is a back perspective view of a transmission plate according to a non-restrictive illustrative embodiment of the present invention;

FIG. 2 is a front perspective view of a transmission plate according to a non-restrictive illustrative embodiment of the present invention;

FIG. 3 schematic cross-sectional view taken along line B-B of FIG. 7 of a transmission plate similar to the transmission plate of FIG. 1 mounted into a wall panel and showing an inertial exciter mounted to the transmission plate according to a non-restrictive illustrative embodiment of the present invention;

FIG. 4 is schematic side elevational view of the transmission plate of FIG. 1 according to a non-restrictive illustrative embodiment of the present invention;

FIG. 5 is schematic front elevational view of the transmission plate of FIG. 1 according to a non-restrictive illustrative embodiment of the present invention;

FIG. 6 is schematic top view of the panel of FIG. 1 according to a non-restrictive illustrative embodiment of the present invention;

FIG. 7 is schematic back elevational view of the transmission plate of FIG. 1 according to a non-restrictive illustrative embodiment of the present invention;

FIG. 8 is a schematic cross-sectional view taken along line A-A of FIG. 6 of a transmission plate similar to the transmission plate of FIG. 1 according to a non-restrictive illustrative embodiment of the present invention;

FIG. 9 is a schematic cross-sectional view of a transmission plate for composite panel systems comprising an upper and lower structural skin with a center core according to a non-restrictive illustrative embodiment of the present invention;

FIG. 10 is a sectional elevation view of FIG. 9 according to a non-restrictive illustrative embodiment of the present invention.

### DETAILED DESCRIPTION OF THE INVENTION

The present invention relates to an audio transmission fidelity augmentation interface bridging an inertial type audio transducer and a substrate into which it is transmitting acoustical energy. The interface will be described in two non-restrictive illustrative embodiments as a plate or as sectional fingers having several features that act as a bridging interface between an inertial type acoustic transducer and a substrate to which the transducer is driving. The interface permits an increased level of acoustic fidelity to be transmitted to the substrate as compared to placing the transducer directly onto the substrate as well as offering means to facilitate the transducer's installation and permit installation to various substrate thicknesses. The interface also provides for installing the transducer in a manner whereby it is not visually apparent to the user of the transducer.

A plate for use as an acoustical transmission interface, according to non-restrictive illustrative embodiments of the present invention, will now be described. In a first embodiment, the plate comprises of a disk having several features to facilitate its assembly to a substrate and an inertial type acoustical transducer. It is to be noted that the illustrative embodiment features a plate generally round in shape; however, it is understood that the plate may be triangular, square or have multiple sides or forms.

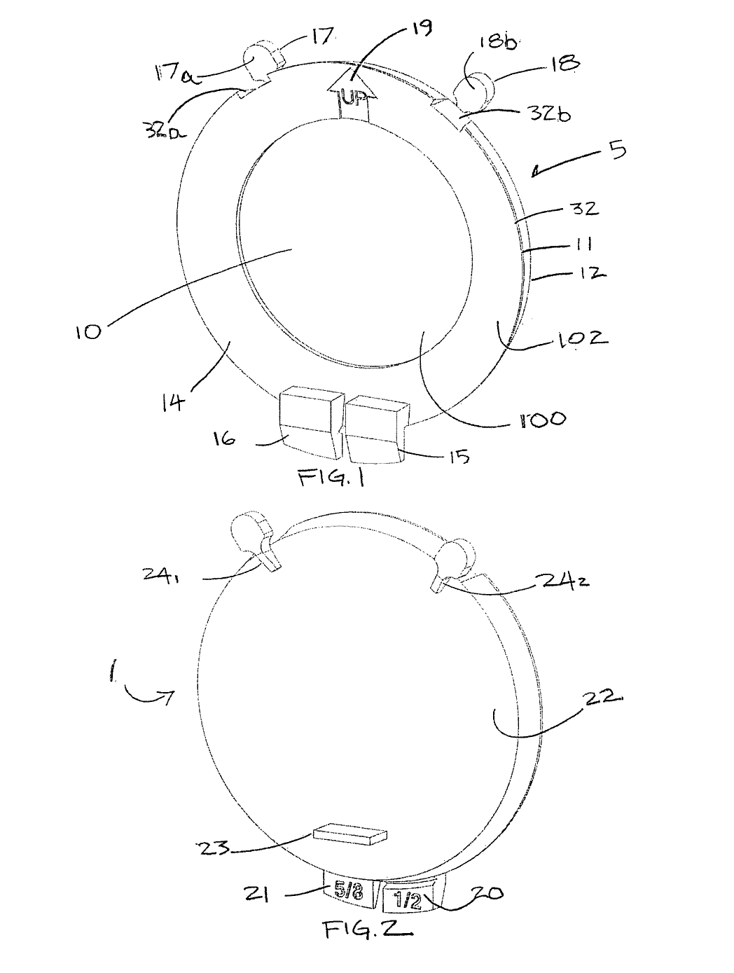

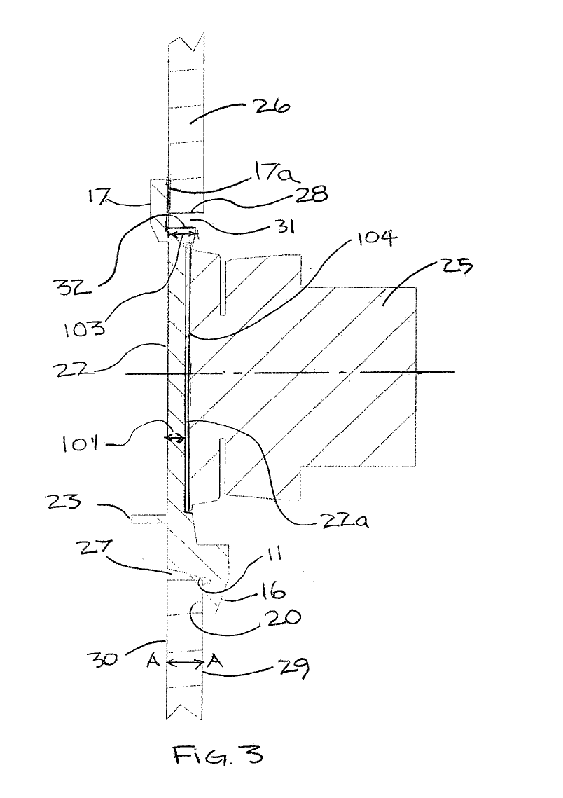

Referring now to FIGS. 1 and 2, an audio transmission fidelity augmentation interface 1 comprising a plate assembly 5 is described. The plate assembly 5 comprises a plate 10 characterized by a perimeter band 11, which is preferably beveled outward from a front edge 12. The plate 10 is further characterized by a first portion 100 and a second portion 102 said first portion 100 comprising a first thickness 101 and said second portion 102 comprising a second thickness 103. The first thickness 101 is preferably the thinner of the two 101, and 103. The plate 10 comprises an inner side 22a and an outer side 22. An acoustic transducer 25 is associated with the inner side 22a of the first portion 100 of the plate 10 by means to affix said audio transducer 104. In the preferred embodiment, the second thickness 103 of said second portion 102 is thicker than said first thickness 101 of the first portion 100 and forms a ring element 14. The thinner section 101 of the plate 10 facilitates the transmission of high frequency vibration from the transducer 25 through the plate and finally to a substrate 26.

Still referring to FIG. 1 and FIGS. 2, 3 and 5 other features assist with the placement and securement of plate 10 into the substrate 26 having an inner surface 29 and an outer surface 30 and an opening 31 said opening comprising a circumference surface 28. As shown in FIG. 3, means to affix 104 the audio transducer 25 preferably comprises adhesive but may include any other mechanical hardware such as clips, screws, and tabs capable of affixing the transducer 25 to the inner side 22a of the first portion 100 of the plate 10. Substrate 26 has the opening 31 perforating it in order to accommodate the transducer 25 and plate assembly 5. The hole 31 is equal to or slightly larger than said perimeter 11 of the plate 10. As the transducer 25 is cantilevered past the plane of the substrate 26, the weight of the transducer 25 causes a moment of rotation, rotating it towards the inner surface 29 of the substrate 26. At least one tab 15 and, preferably a second tab 16 or more work with at least one stop 17 and, preferably a second stop 18 or more to counter this rotational moment permitting the plate assembly 5 to be stably positioned on substrate 26.

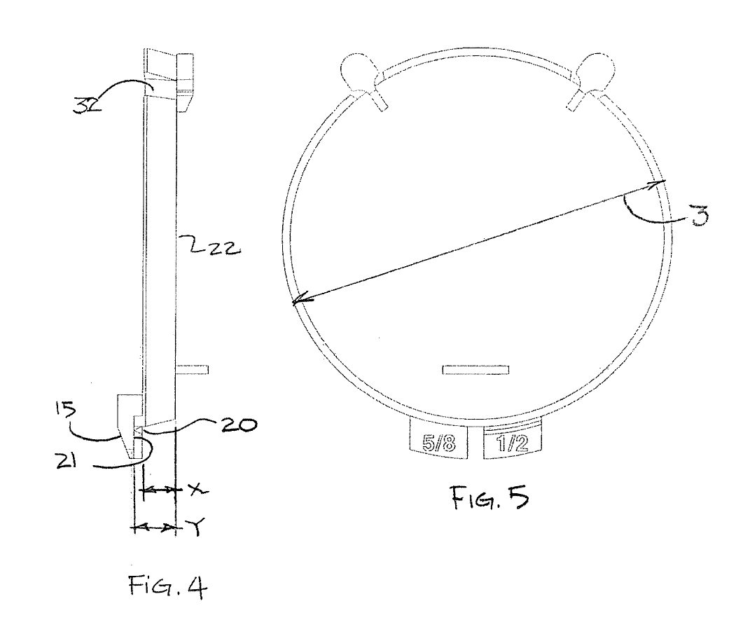

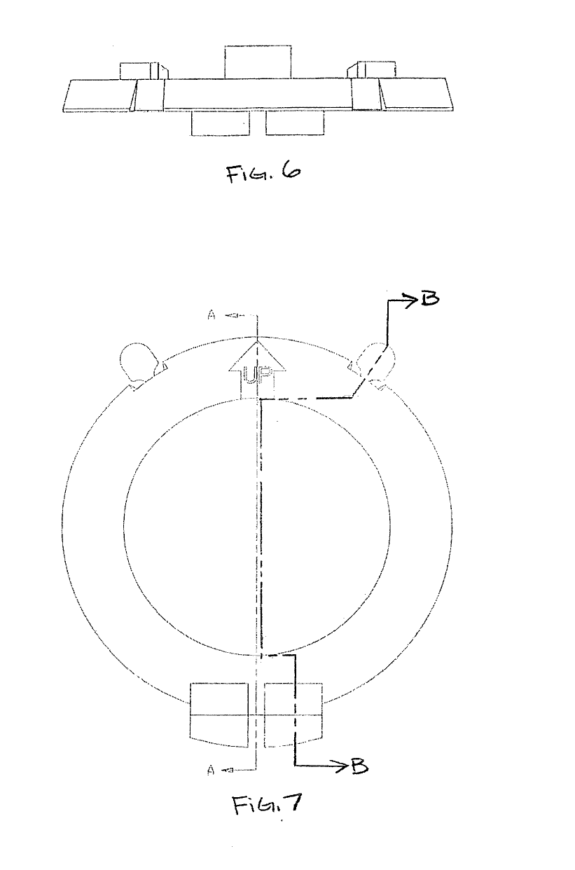

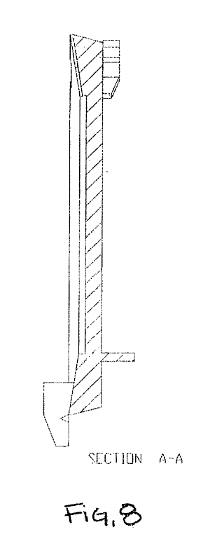

Describing in more detail the function of the stops 17 and 18 as well as tabs 16 and 15 when the plate assembly 5 is inserted in opening 31, we refer to FIG. 3 and FIG. 4. It should be noted that in a preferred embodiment, tab 16 comprises a contacting surface 21 and tab 15 comprises a contacting surface 20. These surfaces 20 and 21 are designed to make contact with the substrate 26 at its inner surface 29. In the most preferred embodiment tabs 16 and 15 in combination with a bevel of the perimeter 12 form a gap 27 between substrate 26 and perimeter 11. Further, in the most preferred embodiment, the second thickness 103 at the perimeter 11 of the second portion 102 is generally but not always equal to the thickness of the substrate 26. According to the shape of the tabs 15 and 16, the contacting surfaces 20 and 21, are spaced from the outer surface of the plate 22 by a distance indicated by arrow A-A in FIG. 3 which also represents the thickness of the substrate 26. In a preferred embodiment, the spacing of the contacting surfaces 20 and 21 from the outer surface of the plate 22 each represent a standard production thickness of a given substrate, and by way of example a ½″ or ⅝″ standard gypsum panel. It should be noted that these tabs can be reduced to one or several. This adds flexibility in a singular plate 10 which can be used for various panel thicknesses by simply removing the tabs that do not have a contacting surface spaced at the appropriate distance relative to the substrate employed.

During the installation process of the audio transmission fidelity augmentation device, the person installing the plate assembly 5 comprising the transducer 25 can easily remove by way of breaking off either of the two tabs 15 or 16, leaving the tab of the desired dimension X, or Y to mate with the thickness of the substrate 26. This would position the surface 22 of the plate 10 to be at the same level as the outside surface 30 of the substrate 26.

If the device 1 is for use with gypsum type panels as described in this non-restrictive illustrative embodiment, it should noted that the plate 10 can be molded or otherwise formed from a stiff, possibly reinforced plaster type material. The reinforcement is typically, but not limited to chopped glass fiber, E type. Those skilled in the art will recognize that other structural fibers can be utilized as well. A commercial example of this material is USG HydroCal FRG-95 available from the Industrial Products Division of the United States Gypsum Company.

Describing the positioning and securing of the plate 10 further, the moment rotational force is balanced by the stops 17 and 18. Each stop comprises a contacting surface, 17a and 18a respectively. The contacting surface 17a or 18a abuts the outer surface 30 of substrate 26. The plate 10 with the transducer 25 affixed to it is now assembled in equilibrium in the substrate 26. Means to further secure 30 the plate 10 to the substrate 26 may be employed. In this case, a joint setting type plaster putty can be troweled into gap 27 forming a consistent space between the perimeter surface 11 of the plate 10, and circumference surface 28. In a more preferred embodiment and shown in FIG. 1, demolding niches 32a and 32b are positioned behind tabs 17 and 18. To stabilize and position the plate 10 during the troweling of the plaster joint compound in to gap 27, the installer may hold handle a 23 which can be removed thereafter.

Once filled and set, means to further secure 30 which may comprise the setting joint plaster can be sanded so as to ensure the entire perimeter 11 has bonded contact with circumference surface 28. Further, the outer surface of the plate 22 may be made to be substantially coplaner with the outside surface 30 of the substrate 26 by sanding, breaking or otherwise removing now unwanted features such as tabs 17 and 18 as well as handle 23.

This assembly method provides acoustic coupling between the gypsum plate and the gypsum wall panel. The setting type joint plaster is preferably fundamentally the same chemical basis as the plate and wall board, calcium sulfate hemihydrate. The setting type plaster forms crystalline bonds between all components.

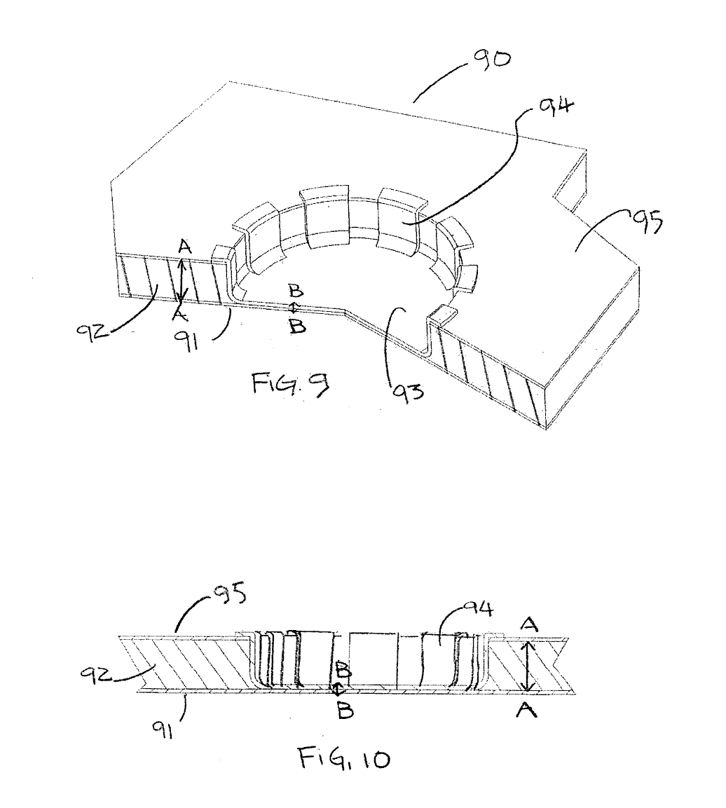

Referring now to a second embodiment of the interface, FIG. 9, and FIG. 10 show a composite panel 90 as the substrate 26 consisting of an outer structural skin 91, an inner structural skin 95, a center core 92. The interface comprises a transmission plate 93 which is actually a portion of the outer structural skin 91 and a plurality of sectional fingers 94. The interface is designed to have geometry which when bonded to the skin 91 and the core 92 will match the panel flexural bending stiffness. Specifically, the sectional fingers 94 which have root geometry, radial extent and wall thickness, also have bending stiffness, which when bonded to the outer structural skin 91, center core 92 and inside skin 95 will match the overall bending stiffness of the composite panel 90. In practice, the transducer 25 is inserted and affixed to the transmission plate 93 and thereby hidden from view while transducing sound.

Although the present invention has been described hereinabove by way of non-restrictive, illustrative embodiments thereof, these embodiments can be modified at will, within the scope of the appended claims, without departing from the spirit and nature of the subject invention.

1. An acoustical transmission interface comprising:
a plate comprising a perimeter and a first portion having a first thickness and a second portion having a second thickness wherein said first thickness is thinner than said second thickness,
an inertial type audio transducer; and
means to affix said audio transducer and said first portion of said plate.

2. The interface of claim 1 wherein said plate further comprises an outer side, an inner side, at least one tab association with said inner side extending beyond said perimeter and at least one stop associated with said outer side of the plate extending beyond said perimeter.

3. The interface of claim 1 wherein said plate comprises an inner side and an outer side and said audio transducer is associated with said inner side of said first portion of said plate.

4. The interface of claim 3 further comprising a substrate having an outer surface wherein said plate further comprises at least one tab having a contacting surface spaced from the outer surface of said substrate by a distance equal to a thickness of said substrate for positioning said plate relative to said substrate.

5. The interface of claim 4 wherein said outer side of said plate and said outer side of said substrate are generally coplaner.

6. A method for maintaining wave input impedance and bending wave cricial speed comprising:
a) a plate having a first portion of a first thickness and a second portion of a second thickness;
b) affixing a first surface of an audio transducer to an inner side of said plate at said first portion; and
c) inserting a second side of said audio transducer through an opening in a substrate.

7. The method of claim 6 further comprising securing said plate in said opening comprising countering rotational moment by at least one tab.

8. The method of claim 7 wherein said at least one tab is associated with an inner side of said plate.

9. The method of claim 7 wherein said at least one tab comprises a contact surface positioned to be spaced a distance from an outer surface of the substrate by a distance substantially equal to a thickness of the substrate.

10. An acoustical transmission interface comprising:
a) a substrate having an opening;
b) a plate having an inner surface and an outer surface and comprising a tab associated with said inner surface and a stop associated with said outer surface, wherein said tab and said stop position said plate within the opening;
c) an audio transducer;
d) means for affixing said audio transducer to said inner surface of said plate; and
e) said audio transducer extending through the opening in the substrate.

11. The interface of claim 10 wherein said plate further comprises a first portion having a first thickness and a second portion having a second thickness, said first thickness being less than said second thickness, and said audio transducer affixed to said first portion of said plate.

12. The interface of claim 10 wherein said tab comprises at least one contact surface spaced a distance from an outer surface of said substrate by a distance substantially equal to a thickness of said substrate.

13. The interface of claim 10 wherein said tab comprises a construction including a contacting surface, said contacting surface contacts an outer surface of said substrate causing said outer surface of said substrate to be positioned generally coplaner with the outer side of said plate.

14. The interface of claim 4 wherein said substrate comprises a core modulus and said plate comprises a high modulus material of about 5 times the stiffness of the substrate core modulus.

15. The interface of claim 4 wherein said substrate comprises a thickness and said first thickness is between about 10% and about 80% of the substrate thickness.

16. The interface of claim 4 further comprising a plaster type joint setting compound comprising a high modulus nature to facilitate transmission of mechanical vibration by the inertial type transducer and to further secure the position of said plate relative to said substrate.

17. A plate as described in claim 1 wherein said perimeter is beveled for facilitating the insertion of a bonding agent to affix said plate relative to a substrate.

18. An acoustical transmission interface comprising:
a) a composite panel having an inner skin, an outer skin, a core and a portion wherein said inner skin and said core are removed thereby leaving a transmission plate;
b) a plurality of fingers for substantially matching the bending stiffness of the composite panel; and
c) an acoustic transducer.

19. The interface of claim 18 wherein each of said plurality of fingers is positioned in said portion and associated with said outer skin, said core and said inner skin.

20. The interface of claim 1 further comprising said acoustic transducer positioned in said portion and adjacent said transmission plate and said plurality of fingers.

21. An acoustical transmission interface comprising:
a) a composite panel having an inner skin, an outer skin, a core and a portion wherein said inner skin and said core are removed thereby leaving a transmission plate;
b) a cylinder positioned in said portion associated with said core, said inner skin and said transmission plate for substantially matching the bending stiffness of the composite panel; and
c) an acoustic transducer.
